(19) United States
(12) Patent Application Publication
(10) Pub. No.: US 2010/0181741 A1
(43) Pub. Date: Jul. 22, 2010

(54) Truck Bed Step and Method

(76) Inventor: Allen R. Webb, Adamsville, AL (US)

Correspondence Address: ALLEN RAY WEBB, 2620 SHADY GROVE ROAD, ADAMSVILLE, AL, 35005, US

(21) Appl. No.: 12/354,991

(22) Filed: Jan. 16, 2009

(51) Int. Cl. B60R 3/00

(52) U.S. Cl. 280/166

(57) ABSTRACT

The present disclosure is a truck bed step that has a mounting device secured to an inside wall of a tailgate. The truck bed step further has at least one collapsible step hingedly coupled to the mounting device that hingedly collapses and attaches to the mounting device while not in use.

### BACKGROUND OF THE INVENTION

Trucks often comprise an open truck bed that is accessible through a tailgate. The truck bed can be used to haul freight. However, in order to make full use of the entire truck bed, it is often that one jumps into the truck bed to place freight in the depths of the truck bed.

### SUMMARY OF THE INVENTION

Generally, the present invention provides a truck bed step and method. In particular, a truck bed step in accordance with an embodiment of the present disclosure mounts to a tailgate of a truck bed and collapses when not in use while still coupled to the tailgate.

A truck bed step in accordance with an embodiment of the present disclosure comprises a mounting device secured to an inside wall of a tailgate and to the at least on collapsible step. In addition, the truck bed step comprises at least one collapsible step hingedly coupled to the mounting device that hingedly collapses and attaches to the mounting device while not in use.

### BRIEF DESCRIPTION OF THE DRAWINGS

The invention can be better understood with reference to the following drawings. The elements of the drawings are not necessarily to scale relative to each other, emphasis instead being placed upon clearly illustrating the principles of the invention. Furthermore, like reference numerals designate corresponding parts throughout the figures.

FIG. 1 is a perspective view of an expanded truck bed step in accordance with an embodiment of the present disclosure.

FIG. 2 is a perspective view of portion of an exemplary handrail of the expanded truck bed step as depicted in FIG. 1.

FIG. 3 is a perspective view a vertical member of the exemplary handrail of the expanded truck bed step as depicted in FIG. 2 after it is removed from a receptacle in accordance with an embodiment of the present disclosure.

FIG. 4 is a perspective view the vertical member as depicted in FIG. 3 after removal as it is rotated in accordance with an embodiment of the present disclosure.

FIG. 5 is a perspective view the vertical member after it is coupled to an exemplary angled member of the handrail of the truck bed step as depicted in FIG. 1.

FIG. 6 is a perspective view of a coupler of the vertical member depicted in FIG. 5.

FIG. 7 is a perspective view of a coupler of the angled member depicted in FIG. 5

FIG. 8 depicts the vertical members and the angled member of the handrail of the truck bed step depicted in FIG. 1 after the members have been contracted.

FIG. 9 is a perspective view depicting rotation of the vertical members and the angled member as depicted in FIG. 8.

FIG. 10 is a plan view of a coupler and one of the vertical members of the handrail depicted in FIG. 1 illustrating a tube within the vertical member and the coupler that enables the vertical members and the angled member to rotate.

FIG. 11 is a top cross-sectional view of the vertical member depicted in FIG. 10.

FIG. 12 is a side plan view of the vertical member depicted in FIG. 11.

FIG. 13 is a perspective view of a step of the truck bed step depicted in FIG. 1 being rotated.

FIG. 14 is a perspective view of the step of FIG. 13 after it is fully rotated.

FIG. 15 is a perspective view of the step of the truck bed step depicted in FIG. 13 being rotated a second time.

FIG. 16 is a perspective view of the step in FIG. 15 after it is completely rotated.

FIG. 17 is a perspective view of the steps after the steps have been rotated as depicted in FIG. 16.

FIG. 18 is a perspective view of the steps of FIG. 17 as they are rotated toward a mounting plate as depicted in FIG. 1.

FIG. 19 is a perspective view of the truck bed step of FIG. 1 after the steps are completely contracted.

FIG. 20 is a perspective view depicting the handrail of FIG. 1 as it is contracted.

FIG. 21 is a perspective view depicting the handrail of FIG. 20 after it is fully contracted.

FIG. 22 is a side perspective view depicting the truck bed step of FIG. 1 in a completely contracted state.

FIG. 23 is a top perspective view depicting the truck bed step of FIG. 1 in a completely contracted state.

FIG. 24 is a top plan view of depicting the truck bed step of FIG. 1 in a contracted state and a tailgate to which the truck bed step is attached is closed.

FIG. 25 is a perspective view of a mounting plate and a horizontal member of the truck bed step of FIG. 1 in accordance with an embodiment of the present disclosure.

FIG. 26 is a side plan view of the truck bed step in a contracted state.

### DETAILED DESCRIPTION OF THE INVENTION

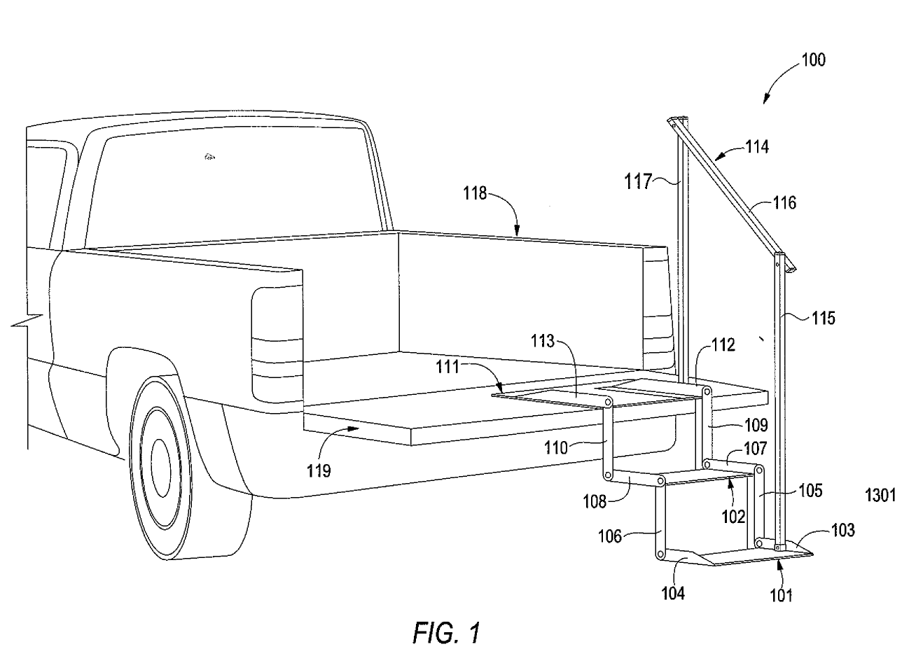

FIG. 1 depicts a truck bed step 100 in accordance with an embodiment of the present disclosure. The truck bed step 100 comprises one or more steps 101 and 102, a mounting plate 111, and a hand rail 114.

The truck bed step 100 is mounted to a tailgate 119 of a truck bed 118. During use, the truck bed step 100 expands, which is depicted in FIG. 1. However, when the truck bed step 100 is not in use, the truck bed step 100 is manually contracted. Further, the truck bed step 100 remains mounted to the tailgate 119 while the truck bed step 100 is contracted and not in use, which is depicted and described further herein.

Step 101 is fixedly coupled to horizontal arms 103 and 104. The horizontal arms 103 and 104 are pivotally coupled to vertical members 105 and 106, respectively. The vertical members 105 and 106 are pivotally coupled to horizontal members 107 and 108, respectively, and step 102 is fixedly coupled to the horizontal members 107 and 108.

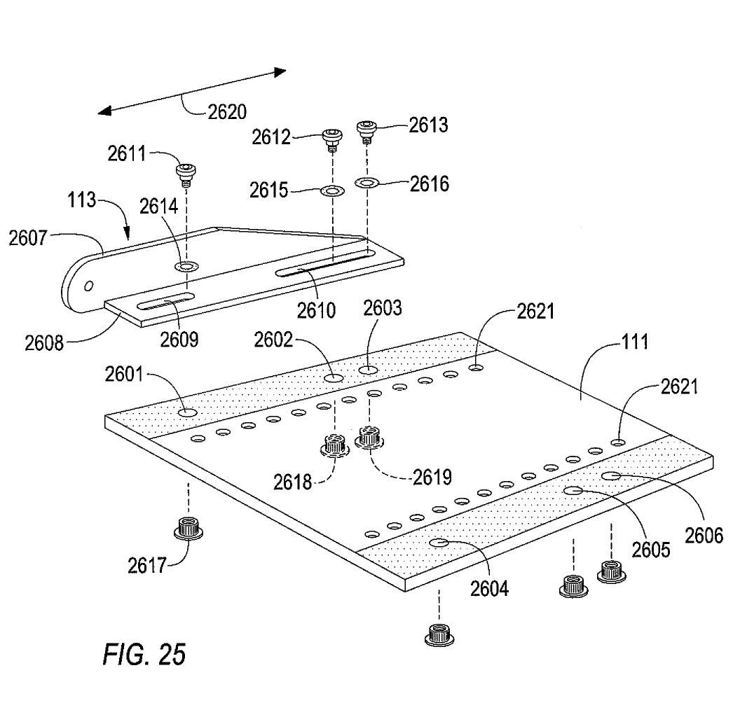

The horizontal members 107 and 108 are pivotally coupled to vertical members 109 and 110, respectively, and the vertical members 109 and 110 are pivotally coupled to horizontal members 112 and 113, respectively. The horizontal members 112 and 113 are slidably coupled to the mounting plate 111, and the mounting plate 111 is fixedly coupled to the tailgate 119 of the truck bed 118. Attachment of the mounting plate 111 to the horizontal members 107 and 108 is further described herein with reference to FIG. 25.

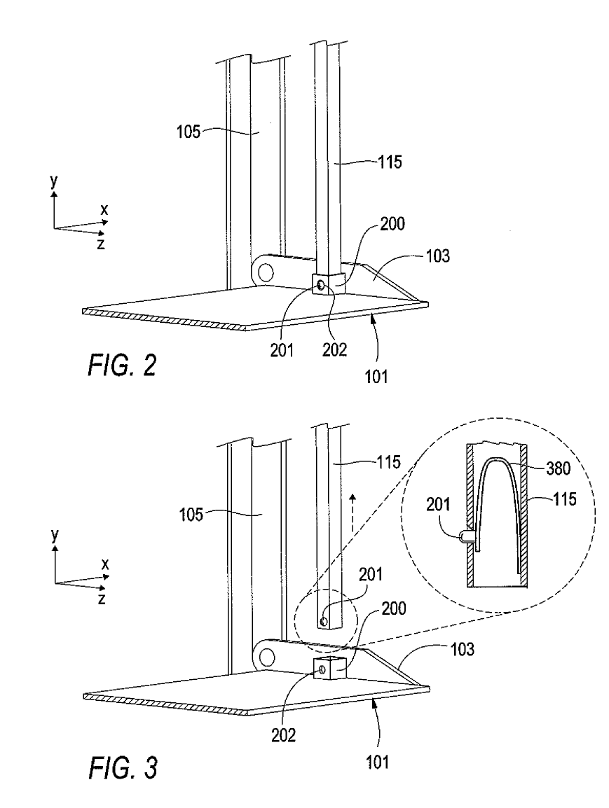

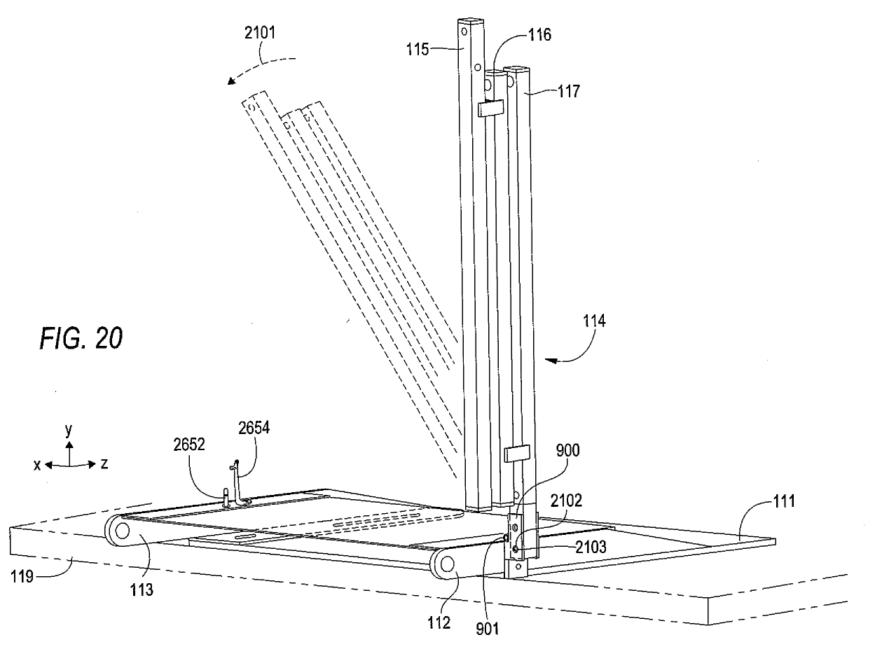

The railing 114 comprises two vertical members 115 and 117 and one substantially angled member 116. The vertical member 115 is detachably coupled to horizontal member 103, which is described further with reference to FIG. 2. Further, the vertical member 115 is pivotally coupled to the angled member 116. The vertical member 117 is rotatably coupled to horizontal member 112, which is described further with reference to FIG. 20. Further, the vertical member 117 is pivotally coupled to the substantially angled member 116.

The truck bed step 100 is depicted in FIG. 1 in an expanded state. The term “expanded” in the present disclosure refers to a state of the truck bed step 100 when the truck bed step 100 may be used to ascend into the truck bed 118. When the truck bed step 100 is expanded, a user can step up into the truck bed 118 by stepping on the steps 101 and 102 using the railing 114 for balance.

FIG. 2 depicts a perspective view of the vertical member 115 detachably coupled to a receptacle 200. In one embodiment, the receptacle 200 is integral and contiguous with the horizontal member 103 and the step 101. Notably, the receptacle 200 can be welded to the horizontal member 103 and/or the step 101. The receptacle 200 has an opening 202 that receives a depressible protrusion 201 located on the vertical member 115.

To begin contracting the truck bed step 100, a user (not shown) dislodges the vertical member 115 from the receptacle 200, as illustrated in FIG. 3. To dislodge the vertical member 115, the user depresses the depressible protrusion 201 and exerts a force on the vertical member 115 in a y direction thereby lifting the vertical member 115 from the receptacle 200.

The cross-sectional view of the vertical member 115 depicts the protrusion 201 attached to a metal spring 380. For example, the metal spring 380 may be comprised of a flexible metal material. When force is applied to the protrusion 201, it moves in the x direction thereby dislodging from the opening 202 so that the vertical member 115 can be lifted in the y direction and removed from the receptacle 200.

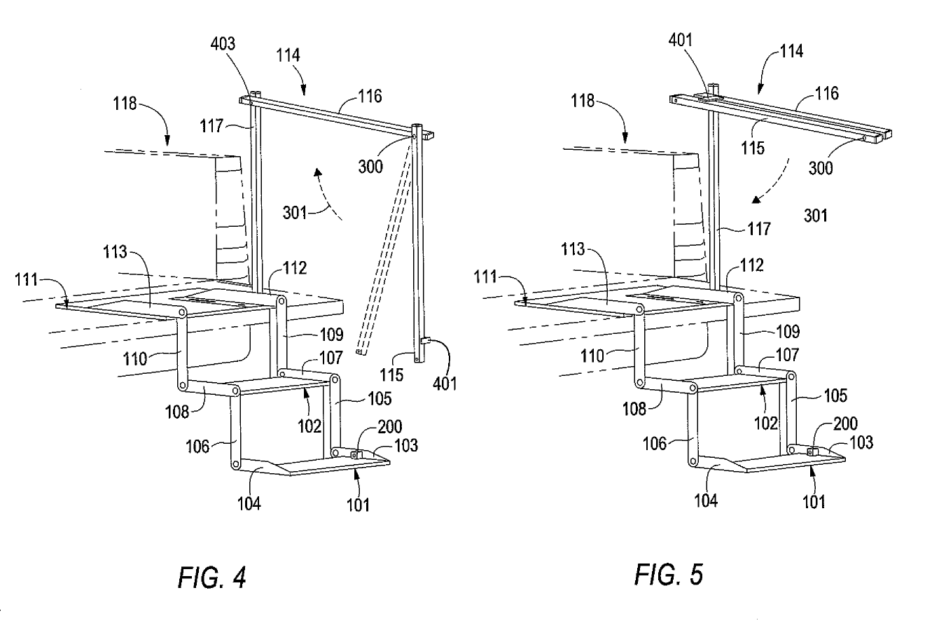

FIG. 4 illustrates the vertical member 115 once it has been dislodged from the receptacle 200. Once the vertical member 115 is dislodged from the receptacle, the user (not shown) rotates the vertical member 115 about a pivot point 300 between the vertical member 115 and the substantially angled member 116 in a direction notated by reference arrow 301.

The vertical member 114 comprises an H-shaped coupler 401. When it is fully rotated in the direction indicated by reference arrow 301, the angled member 116 snugly fits within and is retained by the H-shaped coupler 401.

FIG. 5 depicts the vertical member 115 once the vertical member 115 has been fully rotated. Once the vertical member 115 is fully rotated, it is substantially parallel with the angled member 116. The angled member 116 fits within the H-shaped coupler 401 such that the vertical member 115 is retained substantially parallel with the angled member 116.

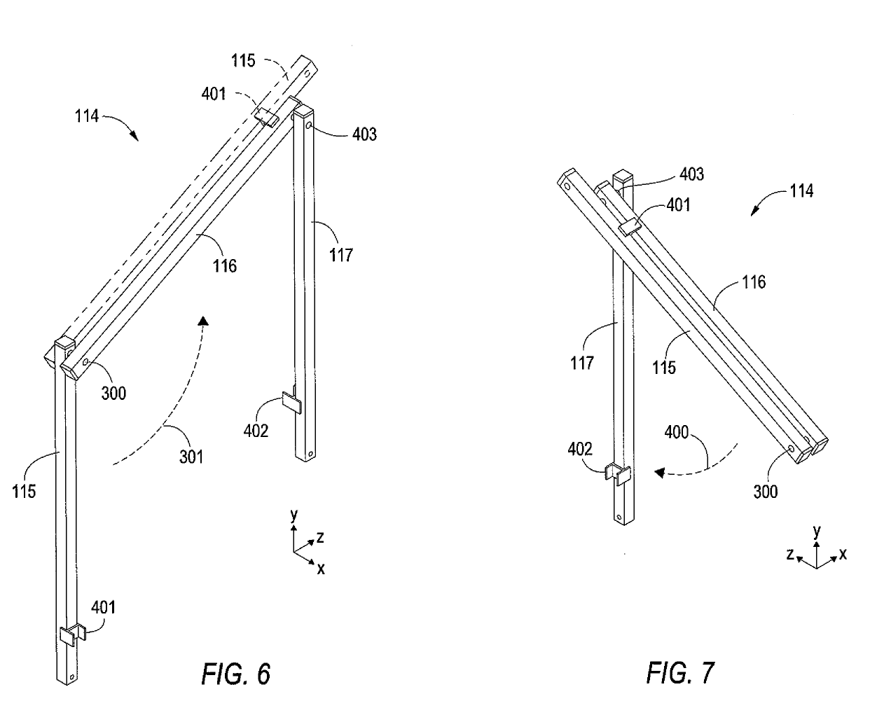

FIG. 6 depicts a perspective view of the H-shaped coupler 401. With reference to FIG. 6, the user rotates the member 115 until the angled member 116 fits within the H-shaped coupler 401 indicated by the dotted line vertical member 115.

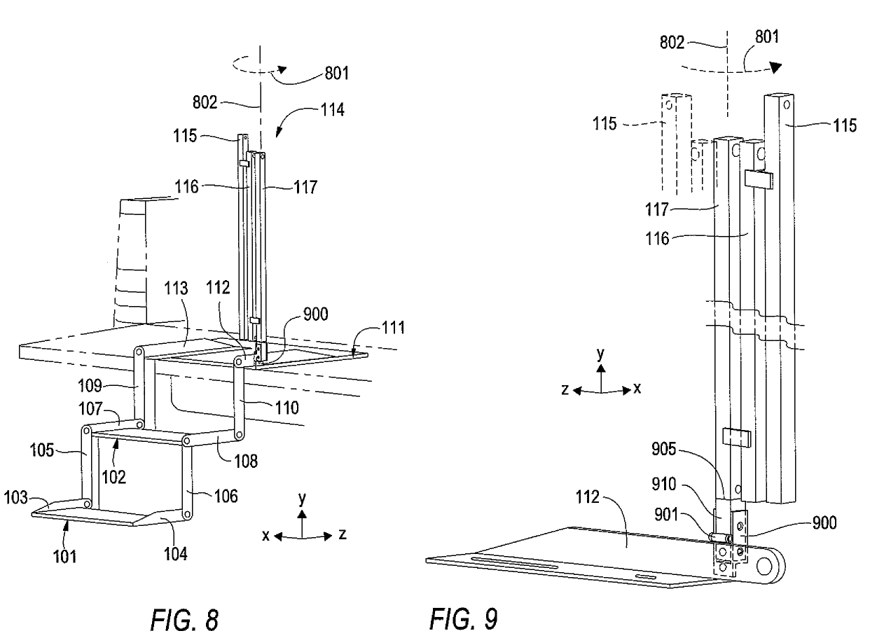

With reference to FIG. 7, once the vertical member 115 is coupled to the angled member 116 via the H-shaped coupler 401, the user rotates the vertical member 115 and the angled member 116 about a pivot point 403 between the angled member 116 and the vertical member 117. The user rotates in a direction notated by reference arrow 400 and in the z direction. Once rotated fully, the vertical member 115 and the angled member 116 are substantially parallel with the vertical member 117, which is shown with reference to FIG. 8.

As shown with reference to FIG. 7, the vertical member 117 comprises the H-shaped coupler 402. The angled member 116 fits within and is retained by the H-shaped coupler 402. Note that H-shaped couplers 401 and 402 couple the members 115-117 such that they are substantially parallel to one another; however, other coupling devices may be used in other embodiments.

FIG. 8 depicts the railing 114 after each of the members 115-117 have been disassembled and coupled together via the couplers 401 (FIG. 7) and 402 (FIG. 7). The members 115-117 are in parallel with one another and are each vertically positioned parallel and upright in the y direction. FIG. 8 depicts the members 115-117 prior to their rotation about an axis 802 in a direction indicated by arrow 801.

FIG. 9 depicts a coupler 900 that is attached to the horizontal member 112. Note that the coupler 900 is hingedly attached, via the hinge 901, to the horizontal member 112 so that the members 115-117 can collapse when not in use, which is described further herein.

The coupler 900 retains a square tubing 910. The rectangular square tubing 910 is rotatably coupled to the vertical member 117 and the member 117 rotates about an intersection 905 between member 117 and the square tubing 910. Thus, once the members 115-117 are in the position shown in FIG. 8, the user rotates members 115-117 in a direction indicated by reference arrow 801 about axis 802 so that the members 115-117 are positioned as shown with respect to FIG. 9.

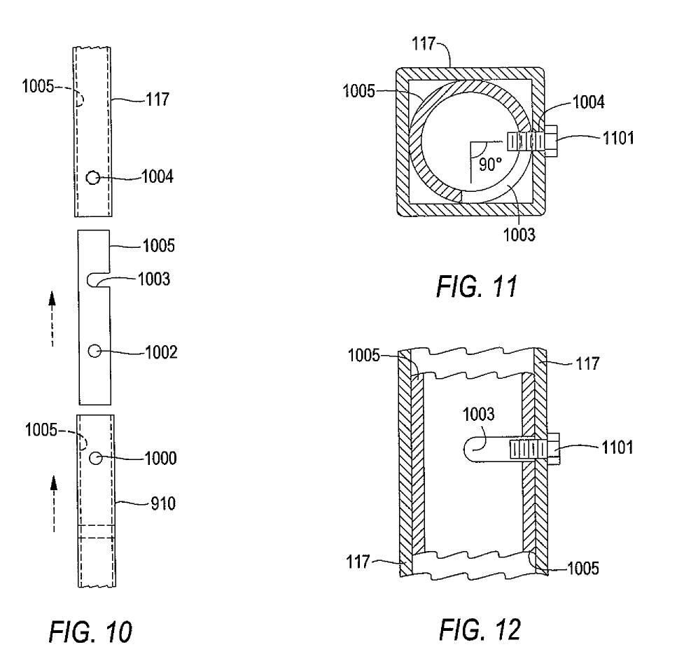

FIG. 10 depicts an exploded view of the member 117 and the square tubing 910. The member 117 and the square tubing 910 are substantially hollow, and within the member 117 is a round tubing 1005 that extends through the member 117 and into the square tubing 910, placement of the round tubing 1005 in the square tubing 910 is illustrated by the dotted lines within the member 117 and the square tubing 910. The round tubing 1005 is coupled to the coupler 900 via a fastener (not shown) that extends through the opening 1000 in the square tubing 910 and the opening 1002 in the round tubing 1005. Thus, the round tubing 1005 is fixedly attached to the coupler 900.

The round tubing 1005 further comprises a slot 1003. In this regard, a fastener (shown with reference to FIG. 12) is received by opening 1004 and the fastener fits within the slot 1003. Thus, when the member 117 is rotated about the intersection 905 (FIG. 9), the round tubing 1005 remains in place while the fastener moves within the slot 1003.

FIG. 11 depicts a cross-sectional view of the member 117. In one embodiment, the slot 1003 is cut in at a ninety-degree angle, as depicted. A bolt 1101 fits through the opening 1004 and the slot 1003 such that the member 117 can rotate ninety degrees within the slot 1003.

FIG. 12 depicts a side plan view of the member 117. The bolt 1101 retains the member 117 mounted while allowing a ninety degree rotation within the slot 1003. Note that the round tubing 1005 may be comprised of a sturdy rubber type of material. The round tubing 1005 retains the member 117 and the square tubing 910 in a position relative to each other yet allows 117 rotate relative to the square tubing 910.

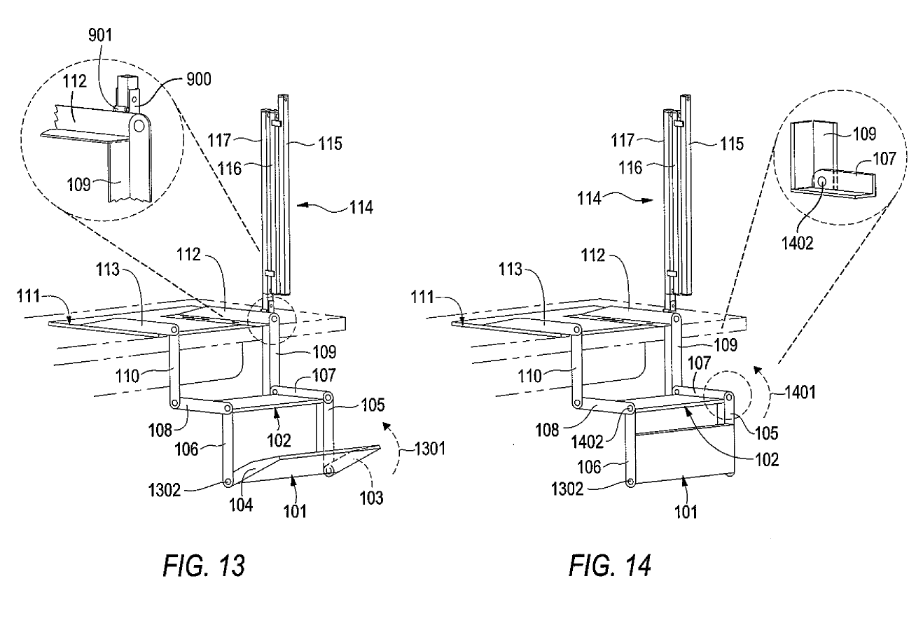

With reference to FIG. 13, the user begins collapsing the truck bed step 100 by lifting step 101 in a direction indicated by reference arrow 1301. Thus, the horizontal members 103 and 104 pivot about a pivot point 1302. After the step 101 is fully rotated, the step 101 and the horizontal members 103 and 104 fit flush with or fit within the vertical members 105 and 106, respectively, as shown with reference to FIG. 14.

Note that FIG. 13 illustrates a detailed depiction of the horizontal member 112. The horizontal member 112 is pivotally attached to the vertical member 109. Further, FIG. 13 depicts the coupler 900 attached to the horizontal member 112 via the hinge 901.

With reference to FIG. 14, the user rotates step 101, including vertical member 105 and vertical member 106 in a direction indicated by reference arrow 1401. In this regard, the vertical members 105 and 106 are pivotally connected to the horizontal members 107 and 108, respectively, at a pivot point 1402. When the user rotates the step 101, the members 105 and 106 pivot about pivot point 1402.

Note that FIG. 14 illustrates a detailed depiction of the horizontal member 107 pivotally connected to the vertical member 109. Once the step 102 is collapsed, the horizontal member 107 rests within the angle of the vertical member 109 so that the horizontal member 107 is flush with the member 109.

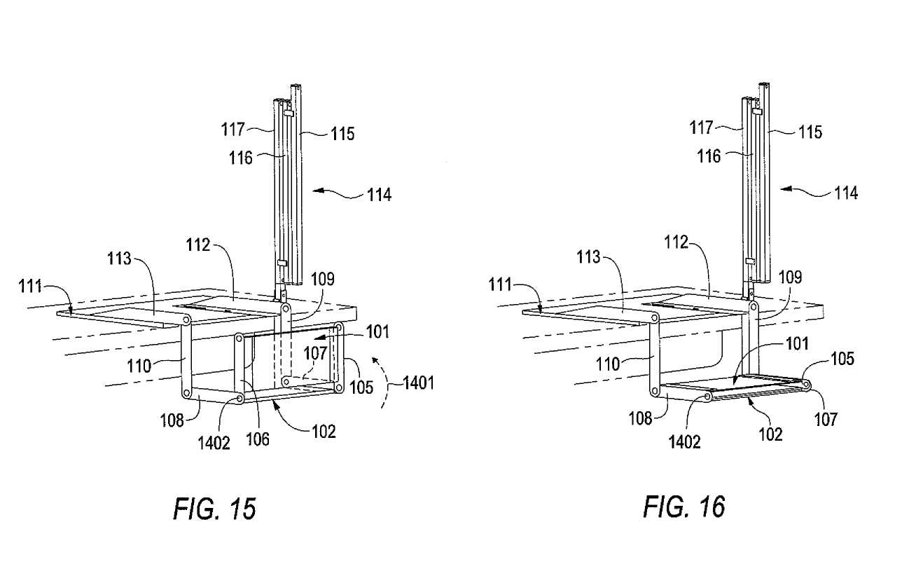

FIG. 15 depicts the step 101 and the members 106 and 107 as the members 106 and 107 pivot about pivot point 1402 in the direction of reference arrow 1401 until the step 101 is fully collapsed, as shown in FIG. 16. When the step 101 is fully collapsed, the step 101 rests upon step 102 (FIG. 12), and the vertical members 105 and 106 fit flush with or fit within the horizontal members 107 and 108.

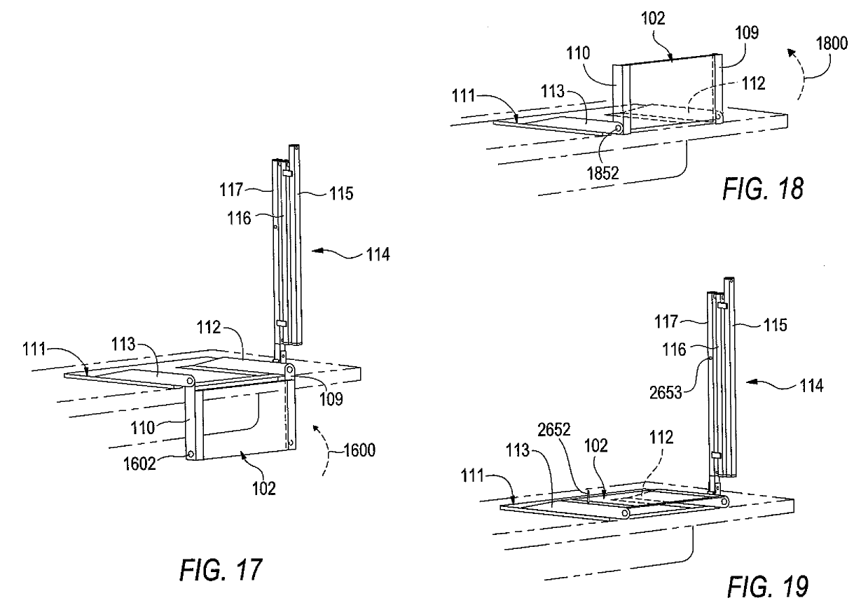

With reference to FIG. 17, the user rotates steps 101 and 102, including the horizontal members 107 and 108 in a direction indicated by reference arrow 1600. In this regard, the horizontal members 107 and 108 are pivotally connected to the vertical members 109 and 110, respectively. When the user rotates the steps 101 and 102 in the direction of reference arrow 1600, the members 107 and 108 pivot about pivot point 1602 until the steps 101 and 102 rest flush with or within vertical members 109 and 110, as depicted in FIG. 17.

With reference to FIG. 18, the user rotates steps 101 (FIG. 16) and 102, including the vertical members 109 and 110, in a direction notated by reference arrow 1800. In this regard, the user rotates steps 101 and 102 until they rest flush with or within horizontal members 112 and 113, as depicted in FIG. 19.

With reference to FIG. 19, the member 113 comprises a protrusion 2652. As will be discussed further herein, an opening 2653 receives the protrusion 2652 when the members 115-117 are rotated about the hinge 901 (FIG. 13) to the collapsed state. The protrusion 2652 is retained by a spring (not shown) within the opening 2653, which is described further with reference to FIG. 26.

With reference to FIG. 20, once the steps 101 (FIG. 1) and 102 (FIG. 1) are collapsed the members 115-117 of the handrail 114 are rotated in a direction notated by reference arrow 2101 about the hinge 901. In this regard, the coupler 900 that mounts the vertical member 117 to the horizontal member 112 comprises an opening 2102 that retains a depressible protrusion 2103 that when depressed releases the members 115-117 so that they can be rotated to a completely contracted position. Note that “completely contracted” with reference to the members 115-117 refers to a position of the members 115-117 such that they are adjacent and parallel the contracted steps 101 and 102.

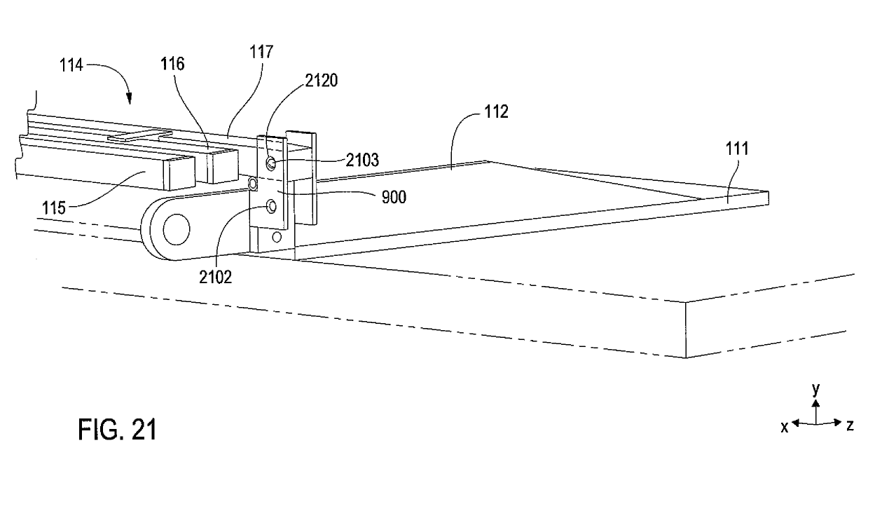

FIG. 21 depicts the members 115-117 of the handrail 114 in one embodiment of the present disclosure. When the members 115-117 are completely collapsed, the members 115-117 are adjacent the horizontal member 112 on the mounting plate 111. Once collapsed, the protrusion 2103 of the coupler 900 fits within opening 2120 as opposed to 2102, as shown.

Again with reference to FIG. 20, the members 115-117 are retained when in a collapsed state. Notably, the protrusion 2652 fits within and is retained by the opening 2653 (FIG. 19). Further, an L-shaped vibration damper hook 2654 receives the member 117. The L-shaped vibration damper hook 2654 provides support for the members 115-117 in the y direction when the tailgate 119 is closed. In one embodiment, the hook 2654 is made of a rubber material so as to mitigate the effects of vibration during movement.

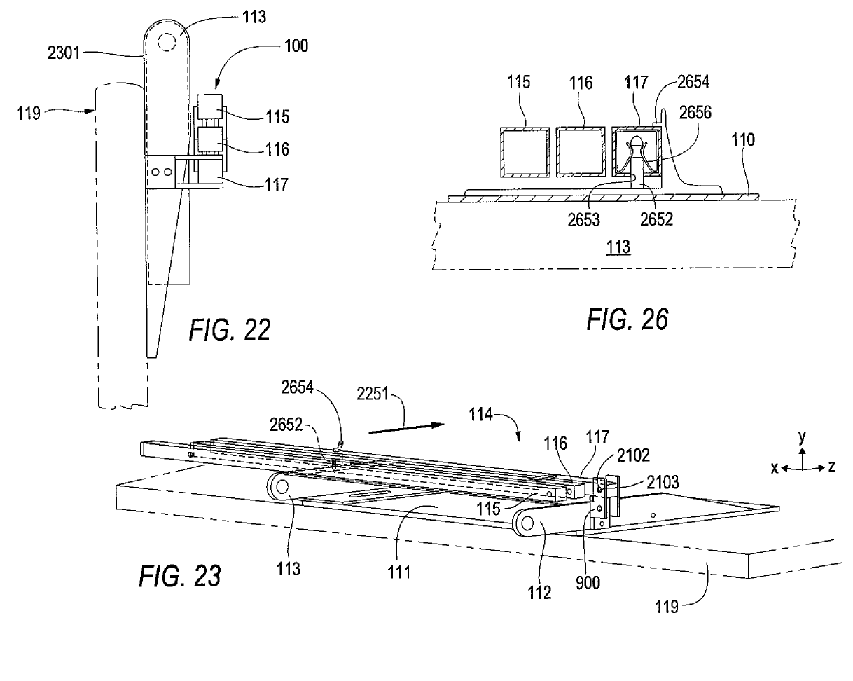

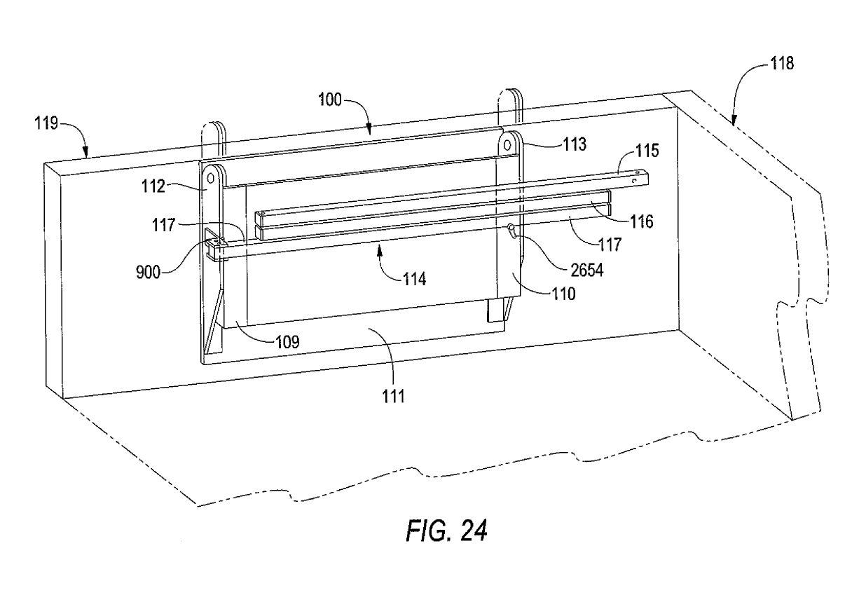

FIG. 22 depicts a side view of the truck bed step 100 in its contracted state and a portion 2301 of the truck bed step 100 extends beyond the tailgate 119. With reference to FIG. 23, and as noted herein with respect to FIG. 1, the horizontal members 112 and 113 are slidably mounted to the mounting plate 111, which is described further herein. Thus, once the truck bed step 100 is contracted, the user applies pressure to the horizontal members 112 and 113 in the direction indicated by reference arrow 2251, and the truck bed step 100 slides such that the portion 2301 (FIG. 22) no longer extends beyond the tailgate 119. This allows the truck bed 118 and the tailgate 119 to be used in a normal manner without the truck bed step 100 getting in the way, such as is further depicted in FIG. 24.

FIG. 24 is a plan view of the truck bed step 100 showing the members 115-117 and the steps 101 and 102 in their fully contracted states. Further, FIG. 24 shows the truck bed step 100 after the members 112 and 113 have been pushed so as to remove any over hang from the tail gate 119. Further, the member 117 rests upon the hook 2654 to mitigate movement of the truck bed step 100 caused from vibrations.

FIG. 25 depicts an exploded view of the mounting plate 111 and one of the horizontal members, horizontal member 113. Note that horizontal member 112 (FIG. 1) is mounted in a similar fashion as horizontal member 113. In this regard, the members 112 and 113 are both slidably mounted to the mounting plate 111.

The mounting plate 111 is preferably bolted to the tailgate 119 (FIG. 1) via one or more bolts (not shown) inserted into a plurality of openings 2621. Further, the mounting plate 111 comprises a plurality of openings 2601-2606. Additionally, a portion of the mounting plate 111, including portions 2698 and 2699, is covered with a Teflon™ coating.

The horizontal member 113 comprises a substantially vertical member 2607 that is perpendicular to a substantially horizontal member 2608, thereby forming the L-shaped horizontal member 113.

The horizontal member 2608 comprises one or more slots 2609 and 2610. One or more mounting bolts 2611-2613 fit within one or more respective Teflon™ washers 2614-2616 and the slots 2609 and 2610. The mounting bolts 2611-2613 are retained by one or more plug nuts 2617-2619. Therefore, as described hereinabove, once the truck bed steps 101 and 102 are completely contracted, the truck bed step 100 can be slid in a direction indicated by reference arrow 2620, so that the truck bed step 100 does not interfere with the normal use of the tailgate 119 and/or the truck bed 118.

FIG. 26 is a side plan view of the truck bed step 100 showing the protrusion 2652. The protrusion 2652 is mounted to the member 110. In addition, the protrusion 2652 fits within the opening 2653 in the member 117 when the truck bed step 100 is collapsed.

Now, therefore, the following is claimed:

1. A truck bed step comprising:
a mounting device secured to an inside wall of a tailgate and to the at least on collapsible step; and
at least one collapsible step hingedly coupled to the mounting device that hingedly collapses and attaches to the mounting device while not in use.

2. The truck bed step of claim 1, further comprising a handrail.

3. The truck bed step of claim 2, wherein the handrail is collapsible and is collapsibly mounted to the mounting device.

4. The truck bed step of claim 1, wherein the mounting device is a mounting plate and the collapsible step is slidably mounted to the mounting plate.
